(19) United States
(12) Patent Application Publication
(10) Pub. No.: US 2017/0093204 A1
(43) Pub. Date: Mar. 30, 2017

(54) Portable Flexible Solar Powered Recharging Device

(71) Applicant: Sherry Knowles, Seabrook, NH (US)

(72) Inventor: Sherry Knowles, Seabrook, NH (US)

(21) Appl. No.: 14/866,863

(22) Filed: Sep. 26, 2015

(51) Int. Cl. H02J 7/35; H02J 7/00

(52) U.S. Cl. CPC H02J 7/355; H02J 7/0045

(57) ABSTRACT

A portable, flexible solar powered recharging device for recharging electronic devices includes a mat that is flexible and that has a front and a back. A central processing unit, a power storage module and a charger are coupled to and positioned in a compartment positioned on the back of the mat. The power storage module is operationally coupled to the central processing unit and the charger. A plurality of solar panels, positioned on the front of the mat, is operationally coupled to the central processing unit and the power storage module. A receptacle, operationally coupled to both the central processing unit and the charger, is coupled to and positioned in a sidewall of the compartment. A plurality of couplers or a plurality of connectors can be coupled to the mat such that the mat is configured to attach or to rest on a support surface.

### BACKGROUND OF THE DISCLOSURE

### Field of the Disclosure

The disclosure relates to recharging devices and more particularly pertains to a new recharging device for recharging electronic devices.

### SUMMARY OF THE DISCLOSURE

An embodiment of the disclosure meets the needs presented above by generally comprising a mat that is flexible and that has a front and a back. A central processing unit, a power storage module and a charger are coupled to and positioned in a compartment positioned on the back of the mat. The power storage module and the charger are operationally coupled to the central processing unit. A plurality of solar panels, positioned on the front of the mat, is operationally coupled to the central processing unit and the power storage module. A receptacle, operationally coupled to both the central processing unit and the charger, is coupled to and positioned in a sidewall of the compartment. A plurality of couplers or a plurality of connectors can be coupled to the mat such that the mat is configured to attach or to rest on a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a portable, flexible solar powered recharging device according to an embodiment of the disclosure.

FIG. 2 is a front view of an embodiment of the disclosure.

FIG. 3 is a back view of an embodiment of the disclosure.

FIG. 4 is a block diagram of an embodiment of the disclosure.

FIG. 5 is a side view of an embodiment of the disclosure.

FIG. 6 is a side view of an embodiment of the disclosure.

### DESCRIPTION OF THE PREFERRED EMBODIMENT

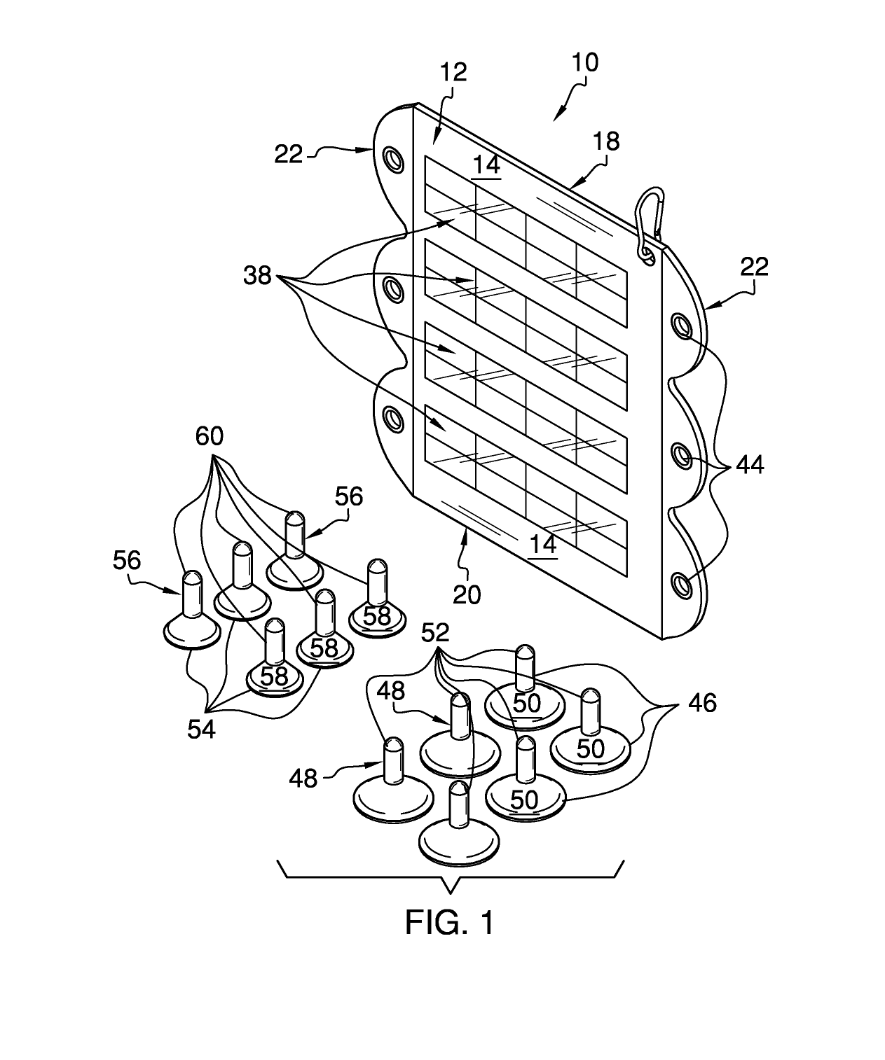

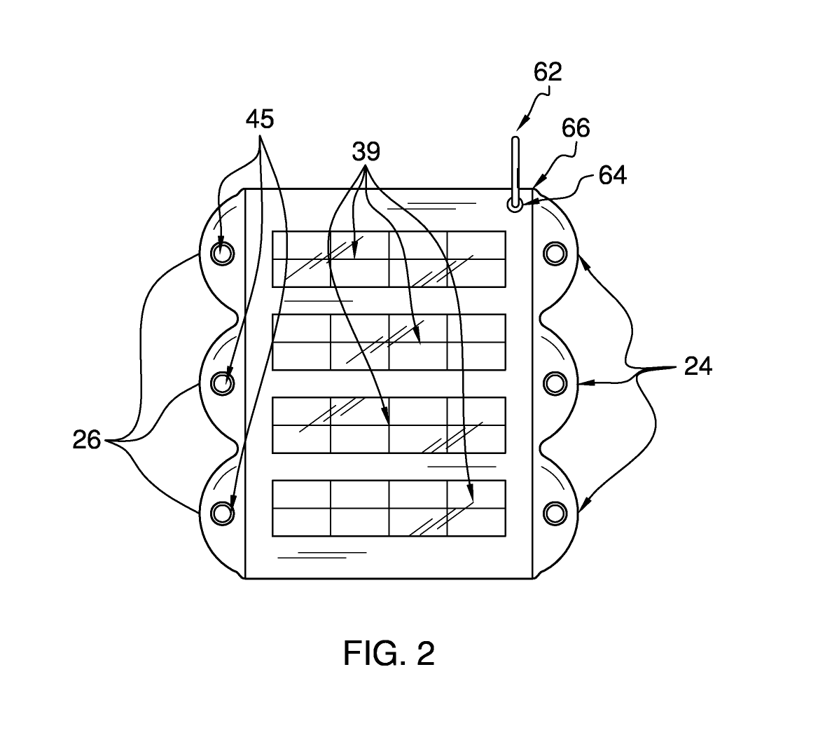

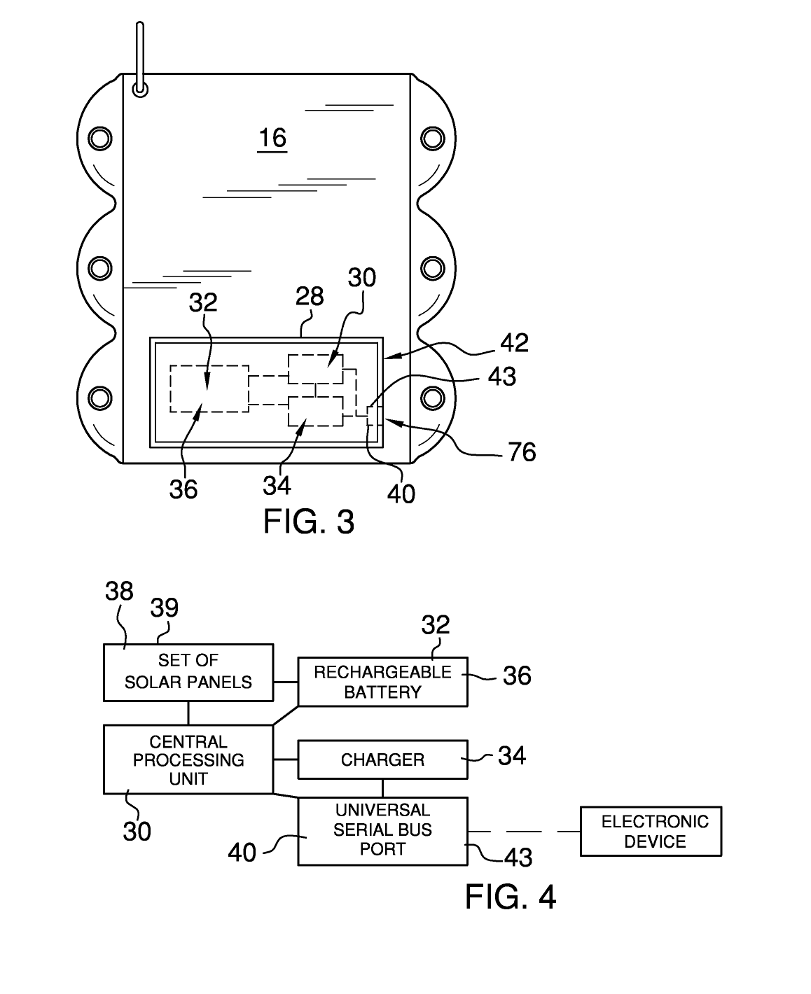

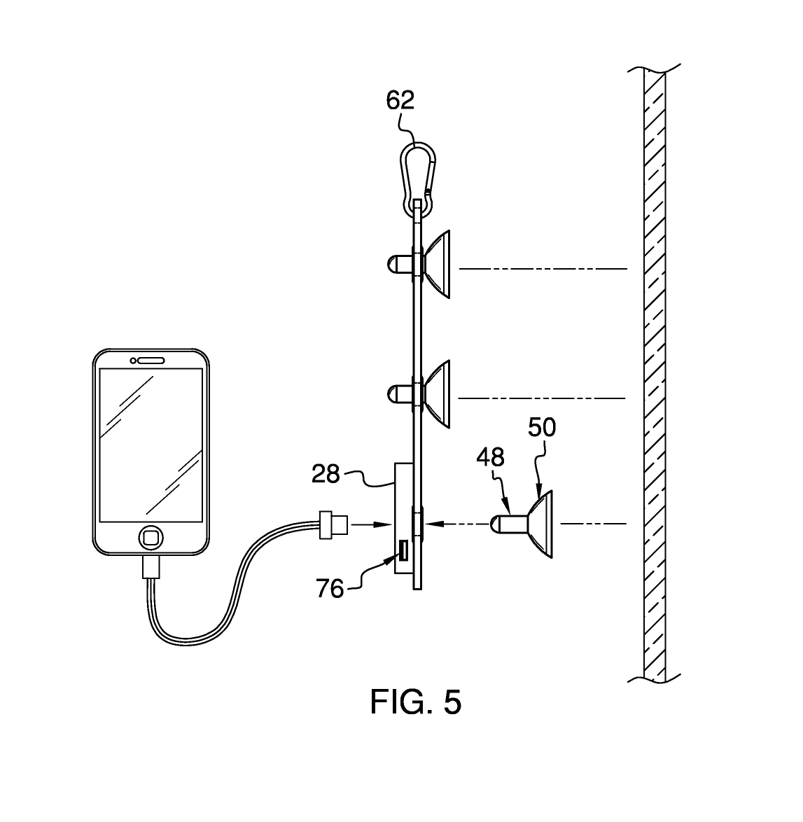

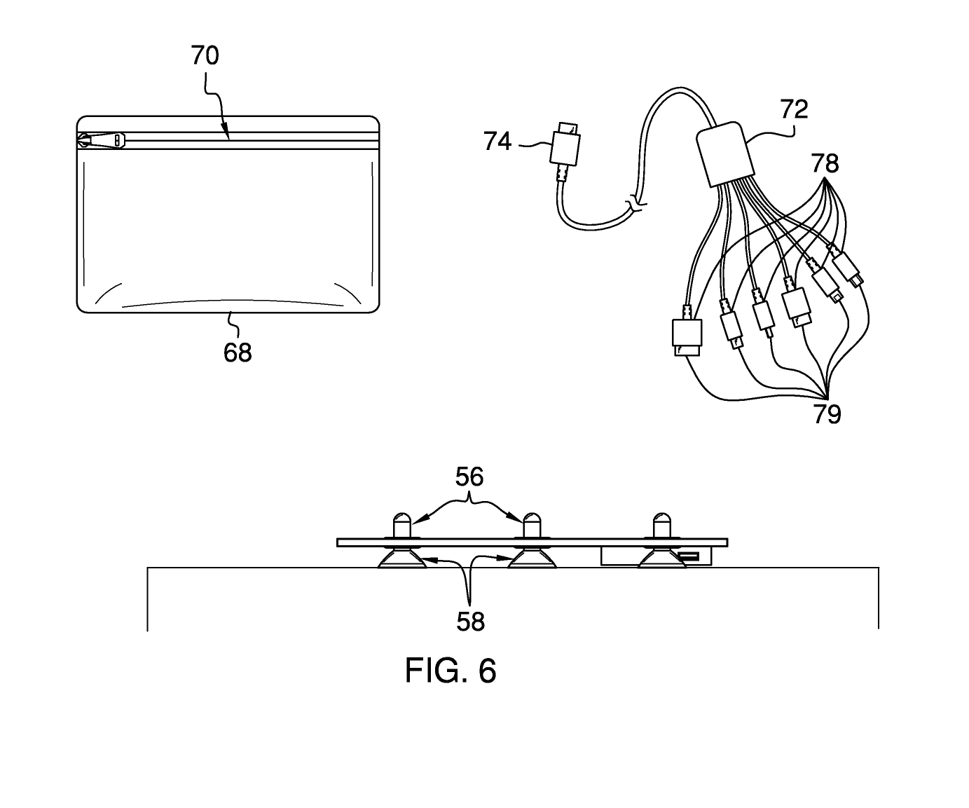

With reference now to the drawings, and in particular to FIGS. 1 through 6 thereof, a new recharging device embodying the principles and concepts of an embodiment of the disclosure and generally designated by the reference numeral 10 will be described.

As best illustrated in FIGS. 1 through 6, the portable, flexible solar powered recharging device 10 generally comprises a mat 12. The mat 12 is flexible and has a front 14, a back 16, a top edge 18, a bottom edge 20, and a pair of side edges 22. Each of the side edges 22 may comprise a polysigmoidal shape 24. Preferably, each of the side edges 22 comprises a set of three arcuate extensions 26. A compartment 28 is positioned on the back 16 of the mat 12. The compartment 28 may be positioned proximate to the bottom edge 20. A central processing unit 30, a power storage module 32 and a charger 34 are coupled to and positioned in the compartment 28. The power storage module 32 is operationally coupled to the central processing unit 30 and comprises at least one rechargeable battery 36. The charger 34 is operationally coupled to the central processing unit 30. A plurality of solar panels is 38 positioned on the front 14 of the mat 12. The plurality of solar panels 38 is operationally coupled to the central processing unit 30 and the power storage module 32. Preferably, the plurality of solar panels 38 comprises a set of four solar panels 39. A receptacle 40 is coupled to and positioned in a sidewall 42 of the compartment 28. The receptacle is 40 operationally coupled to the central processing unit 30 and the charger 34. Preferably, the receptacle 40 is a universal serial bus port 43, such that the mat 12 is configured to be attached to a user's electronic device. A plurality of holes 44 is positioned in and through the mat 12 proximate to the pair of side edges 22. Preferably, the holes 44 are positioned one each in and through each of the arcuate extensions 26. The plurality of holes 44 may be a plurality of grommets 44. A plurality of couplers 46 may be coupled to the mat 12, such that the mat 12 is configured to be attached to a support surface. Each of the couplers 46 may comprise a post 48 extending through and frictionally engaged to an associated one of the holes 42. Each coupler 46 may have a cup 50 coupled to the post 48, such that the cups 50 are configured for vacuum attachment to a support surface. Preferably, the plurality of couplers 46 comprises a set of six couplers 52. Alternatively, a plurality of connectors 54 may be coupled to the mat 12, such that the mat 12 is configured to rest on a support surface. Each of the connectors 54 may comprise a rod 56 extending through and frictionally engaged to an associated one of the holes 42. Each connector 54 may have a base 58 coupled to the rod 56. Preferably, the base 58 is rubber and the plurality of connectors 54 comprises a set of six connectors 60, such that the bases 58 are configured to support the mat 12 on a support surface. The couplers 46 and the connectors 54 are interchangeably couplable to the mat 12. A clip 62 is engaged to an aperture 64 in the mat 12 proximate to an intersection 66 of the top edge 18 and one of the pair of side edges 22. The device 12 also comprises a storage case 68, complementary in size to the mat 12 when the mat 12 is folded, with a zippered opening 70. The device also comprises a universal adaptor 72 with a terminus 74, complimentary to the female connection 76 of the universal serial bus port 42, and a plurality of attachment ends 78. The attachment ends 78 are configured to engage the power input receptacles of a variety of electronic devices. Preferably, the plurality of attachment ends 78 comprises a set of six attachment ends 79.

In use, the user may place the mat 12 with the plurality of solar panels 38 facing a light source to charge the power storage module 32. The user may attach an electronic device requiring a charge to the universal serial bus port 43. The charger 34, under the control of the central processing unit 30, will charge the battery of the electronic device from the power storage module 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable, flexible solar powered recharging device comprising:
a mat, said mat being flexible, said mat having a front, a back, a top edge, a bottom edge, and a pair of side edges;
a compartment, said compartment being positioned on said back of said mat;
a central processing unit, said central processing unit being coupled to and positioned in said compartment;
a power storage module, said power storage module being coupled to and positioned in said compartment, said power storage module being operationally coupled to said central processing unit;
a plurality of solar panels, said plurality of solar panels being positioned on said front of said mat, said plurality of solar panels being operationally coupled to said central processing unit and said power storage module;
a charger, said charger being coupled to and positioned in said compartment, said charger being operationally coupled to said central processing unit;
a receptacle, said receptacle being coupled to and positioned in a sidewall of said compartment, said receptacle being operationally coupled to said central processing unit and said charger, wherein said mat is configured for being attached to a user's electronic device;
a plurality of holes, said holes being positioned in and through said mat proximate to said pair of side edges;
a plurality of couplers coupled to said mat, wherein said mat is configured for being attached to a support surface; and
a plurality of connectors coupled to said mat, wherein said mat is configured for resting on a support surface.

2. The device of claim 1, further including each of said side edges comprising a polysigmoidal shape.

3. The device of claim 1, further including each of said side edges comprising a set of three arcuate extensions.

4. The device of claim 1, further including said compartment being positioned proximate to said bottom edge.

5. The device of claim 1, further including said power storage module comprising at least one rechargeable battery.

6. The device of claim 1, further including said plurality of solar panels comprising a set four solar panels.

7. The device of claim 1, further including said holes being positioned one each in and through each of said arcuate extensions.

8. The device of claim 1, further including said plurality of holes being a plurality of grommets.

9. The device of claim 1, further comprising:
each of said couplers having a post extending through an associated one of said holes, said post being frictionally engaged to said hole; and
each coupler having a cup coupled to said post, wherein said cups are configured for vacuum attachment to a support surface.

10. The device of claim 9, further including said plurality of couplers comprising a set of six couplers.

11. The device of claim 1, further comprising:
each of said connectors having a rod extending through an associated one of said holes, said rod being frictionally engaged to said hole; and
each connector having a base coupled to said rod, wherein said bases are configured to support said mat on a support surface.

12. The device of claim 11, further including said plurality of connectors comprising a set of six connectors.

13. The device of claim 12, further including said base being rubber.

14. The device of claim 1, further including said couplers and said connectors being interchangeably couplable to said mat.

15. The device of claim 1, further including a clip, said clip being engaged to an aperature in said mat proximate to an intersection of said top edge and one of said pair of side edges.

16. The device of claim 1, further including a storage case, said storage case having a zippered opening, said storage case being complementary in size to said mat when said mat is folded.

16. The device of claim 1, further including a universal adaptor, said universal adaptor having a terminus, said terminus being complimentary to said receptacle, said universal adapter having a plurality of attachment ends, said attachment ends being configured to engage a variety of electronic devices.

17. The device of claim 16, further including said plurality of attachment ends comprising a set of six attachment ends.

18. A portable, flexible solar powered recharging device comprising:
a mat, said mat being flexible, said mat having a front, a back, a top edge, a bottom edge, and a pair of side edges, each of said side edges comprising a polysigmoidal shape, each of said side edges comprising a set of three arcuate extensions;
a compartment, said compartment being positioned on said back of said mat, said compartment being positioned proximate to said bottom edge;
a central processing unit, said central processing unit being coupled to and positioned in said compartment;
a power storage module, said power storage module being coupled to and positioned in said compartment, said power storage module being operationally coupled to said central processing unit, said power storage module comprising at least one rechargeable battery;
a plurality of solar panels, said plurality of solar panels being positioned on said front of said mat, said plurality of solar panels being operationally coupled to said central processing unit and said power storage module, said plurality of solar panels comprising a set of four solar panels;
a charger, said charger being coupled to and positioned in said compartment, said charger being operationally coupled to said central processing unit;
a receptacle, said receptacle being coupled to and positioned in a sidewall of said compartment, said receptacle being operationally coupled to said central processing unit and said charger, said receptacle being a universal serial bus port, wherein said mat is configured for being attached to a user's electronic device;
a plurality of holes, said holes being positioned in and through said mat proximate to said pair of side edges, said holes being positioned one each in and through each of said arcuate extensions, said plurality of holes being a plurality of grommets;
a plurality of couplers coupled to said mat, wherein said mat is configured for being attached to a support surface, each of said couplers having a post extending through an associated one of said holes, said post being frictionally engaged to said hole, each coupler having a cup coupled to said post, wherein said cups are configured for vacuum attachment to a support surface, said plurality of couplers comprising a set of six couplers;
a plurality of connectors coupled to said mat, wherein said mat is configured for resting on a support surface, each of said connectors having a rod extending through an associated one of said holes, said rod being frictionally engaged to said hole, each connector having a base coupled to said rod, said base being rubber, said plurality of connectors comprising a set of six connectors, wherein said bases are configured to support said mat on a support surface, said couplers and said connectors being interchangeably couplable to said mat;
a clip, said clip being engaged to an aperture in said mat proximate to an intersection of said top edge and one of said pair of side edges;
a storage case, said storage case having a zippered opening, said storage case being complementary in size to said mat when said mat is folded; and
a universal adaptor, said universal adaptor having a terminus, said terminus being complimentary to said female connection of said universal serial bus port, said universal adapter having a plurality of attachment ends, said attachment ends being configured to engage the power input receptacles of a variety of electronic devices, said plurality of attachment ends comprising a set of six attachment ends,
wherein the user may place said mat with said plurality of solar panels facing a light source to charge said power storage module, and wherein the user may attach an electronic device require charging to said universal serial bus port and said charger, under control by said central processing unit, will charge the battery of the electronic device from said power storage module.
